(19) United States
(12) Patent Application Publication
(10) Pub. No.: US 2016/0116324 A1
(43) Pub. Date: Apr. 28, 2016

(54) MOBILE ULTRASONIC FUEL DETECTION SYSTEM

(71) Applicant: Schmitt Industries, Inc., Portland, OR (US)

(72) Inventors: Christopher A. Job, Forest Grove, OR (US); Mauricio Morafiallos, Beaverton, OR (US); Ken Montero, Portland, OR (US); Kelvin Woltring, Gresham, OR (US); Wayne Case, Portland, OR (US); Christian Staats, Gresham, OR (US)

(73) Assignee: Schmitt Industries, Inc.

(21) Appl. No.: 14/921,739

(22) Filed: Oct. 23, 2015

Related U.S. Application Data
(60) Provisional application No. 62/069,786, filed on Oct. 28, 2014.

(51) Int. Cl. G01F 23/296

(52) U.S. Cl. CPC G01F 23/296

(57) ABSTRACT

A mobile ultrasonic fuel detection system includes an ultrasonic sensor and a control unit. A control unit guard is included to protect the control unit from the external environment and to minimize tampering with the control unit. An activator arm may be included that permits a user to interact with the control unit from the exterior of the control unit guard. The system may also be configured to wirelessly provide measurement data from a remote location. Such data may be obtained manually or automatically according to a predetermined schedule.

### RELATED APPLICATIONS

This application is based on, claims priority to, and includes the information in Provisional Application Ser. No. 62/069,786, filed Oct. 28, 2014, which is incorporated herein by reference.

### TECHNICAL FIELD

The present disclosure relates to ultrasonic measurement systems for sensing a fuel level in a liquid fuel tank.

### BRIEF DESCRIPTION OF THE DRAWINGS

The present embodiments will become more fully apparent from the following description and appended claims, taken in conjunction with the accompanying drawings. Understanding that the accompanying drawings depict only typical embodiments, and are, therefore, not to be considered to be limiting, the embodiments will be described and explained with specificity and detail in reference to the accompanying drawings, in which:

FIG. 1 is a perspective view of an embodiment of an ultrasonic fuel level monitoring system mounted to a mobile fuel tank.

FIG. 2 is a block diagram of an embodiment of a monitoring system.

FIG. 3 illustrates an embodiment of a working environment of a fuel tank and monitoring system.

FIG. 4 is a perspective view of an embodiment of an ultrasonic sensor and sensor guard.

FIG. 5 is a perspective view of an embodiment of a sensor guard mounted to a truck frame.

FIG. 6 is a perspective view of an embodiment of a control unit guard.

FIG. 7 is a perspective view of an embodiment of a control unit mounted to a control unit guard.

FIG. 8 is a perspective view of a control unit guard partially mounted to a truck.

FIG. 9 is a perspective view of a control unit guard mounted to the surface of a truck.

### DETAILED DESCRIPTION

Sensing a liquid level contained in a tank may be performed utilizing sonic measurement techniques. Typically, sonic or ultrasonic measurements are performed with the use of a piezoelectric crystal. If a liquid level is known and the geometry of a tank is known, then the liquid volume in the tank can be calculated based upon the measured level. Such measurement is particularly desirable on fuel tank trucks (e.g., Bobtail trucks, barges, railroad cars, and other transports) in order to keep an accurate accounting of fuel inventory and other fill-level data. However, certain problems can arise in the context of accurately and reliably measuring fuel levels, particularly with respect to taking measurements in a mobile, rather than fixed, fuel tank. Although the disclosure considers liquid fuels such as gasoline, diesel and propane, the disclosure may be equally used for other liquids such as water and liquid fertilizers. Such liquids are equally capable of reflecting a fill level back to an ultrasonic sensor placed on the bottom center of a mobile tank.

One problem is the need to obtain measurements at various locations, including remote locations, as the fuel tank travels from one location to another. Another problem that arises is the need to protect the fuel measurement system from damage that can occur during travel or maintenance. For example, the system may be subject to damage from road hazards or power washes. Another problem is the need to ensure that the fuel measurement system is tamper-resistant or tamper-proof such that the accurate taking of fuel level measurements can be conducted without unwanted disturbances or interruptions caused by unauthorized persons improperly using or otherwise interfering with the system.

Additionally, fuel measurements may need to be taken at specific events or locations. For example, measurements may need to be taken upon arriving at or leaving a refinery. Depending on the specific measurement needs, it may be desirable to take these measurements automatically at pre-set scheduled times or manually when the need arises, or a combination of both.

Accordingly, there exists a need for a mobile fuel measurement system that provides remote measurements, that can provide automatic and/or “On Demand” or manual measurements, that is tamper-proof or tamper-resistant, and that is protected from damage that may occur in the course of travel and/or maintenance or normal operations.

An ultrasonic transducer system to measure a liquid level in a tank is provided. The ultrasonic transducer system may be mounted to a mobile tank. The system may comprise an ultrasonic sensor including an emitter to generate an ultrasonic beam to pass through a tank wall and to receive an echo of the ultrasonic beam off a liquid surface, and a transducer driver in electrical communication with the emitter; a control unit in electrical communication with the ultrasonic sensor; a control unit guard housing the control unit; and an activator arm extending into an interior of the control unit guard and interacting with the control unit to activate on/off states of the ultrasonic sensor.

In various embodiments, the system may be configured to acquire measurements either automatically or manually or both. The system may further be configured to wirelessly transmit measurement data from a remote location.

Additional aspects and advantages will be apparent from the following detailed description of preferred embodiments, which proceeds with reference to the accompanying drawings.

It will be readily understood that the components of the embodiments, as generally described and illustrated in the Figures herein, could be arranged and designed in a wide variety of different configurations. Thus, the following more detailed description of various embodiments, as represented in the Figures, is not intended to limit the scope of the present disclosure, as claimed, but is merely representative of various embodiments. While the various aspects of the embodiments are presented in the drawings, the drawings are not necessarily drawn to scale unless specifically indicated.

The phrases “connected to,” “coupled to” and “in communication with” refer to any form of interaction between two or more entities, including mechanical, electrical, magnetic, electromagnetic, fluid, and thermal interaction. Two components may be coupled to each other even though they are not in direct contact with each other.

Disclosed herein is an ultrasonic fuel level monitoring system for sensing the liquid level in a liquid fuel tank, including a mobile fuel tank such as one carried on a fuel truck or similar vehicle. The system includes an ultrasonic sensor that may be externally mounted on a tank, and a control unit in electrical communication with the ultrasonic sensor. Suitable ultrasonic sensors are described in U.S. Pat. Nos. 7,287,425, 7,245,059, 7,905,143, and 8,412,473, which are incorporated herein by reference in their entireties.

Accordingly, the ultrasonic sensor may comprise a piezoelectric crystal (“piezo”) transducer and a piezo driver circuit, and may also include a temperature sensor. In response to command signals from the control unit, the piezo driver circuit causes the piezo to transmit pulse trains having a controlled pulse frequency.

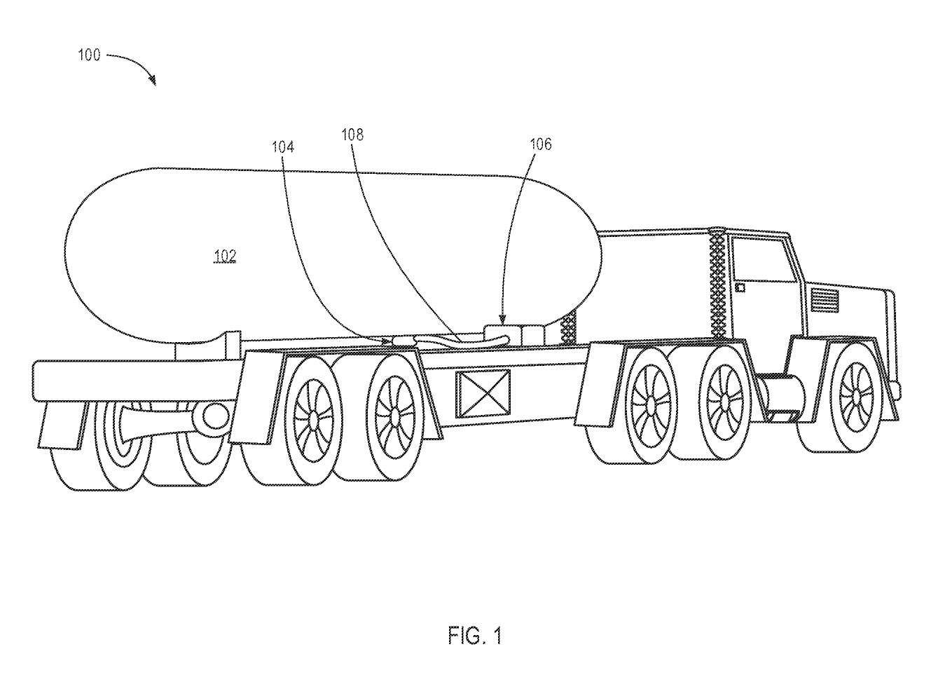

Referring to FIG. 1, an ultrasonic fuel level monitoring system 100 is shown for sensing the liquid level in a tank 102. The system 100 includes an ultrasonic sensor 104 that is externally mounted to the tank 102. The tank 102 may be mounted to a vehicle, such as a fuel truck. Alternatively, the tank 102 may be stationary in that it is not mounted to a vehicle. The tank 102 may be a single-wall or double-wall tank and may include materials such as steel, aluminum, or plastic. The ultrasonic sensor 104 may be mounted to any portion of the tank 102, such as the bottom centerline of the tank 102 as is shown in FIG. 1. The system 100 includes a control unit 106 that is in electrical communication with the ultrasonic sensor 104 through an electrical cable 108. The electrical cable 108 may be configured to provide a synchronous serial data link. The ultrasonic sensor 104 transmits ultrasonic signals through the tank wall and listens for return echoes from the liquid surface (not shown) in the tank 102. The control unit 106 directs the operation of the ultrasonic sensor 104 and collects time-of-flight date and temperature data from the ultrasonic sensor 104.

The control unit 106 may include digital and/or analog circuits to provide processing capability to generate the command signals. In an embodiment of a digital circuit, the control unit 106 may include a processor performing the required computations. The control unit 106 may further include a memory or firmware in electronic communication with the processor to store a computer operating system. Computer operating systems may include, but are not limited to, MS-DOS, Windows, Linux, Unix, AIX, CLIX, QNX, OS/2, and Apple.

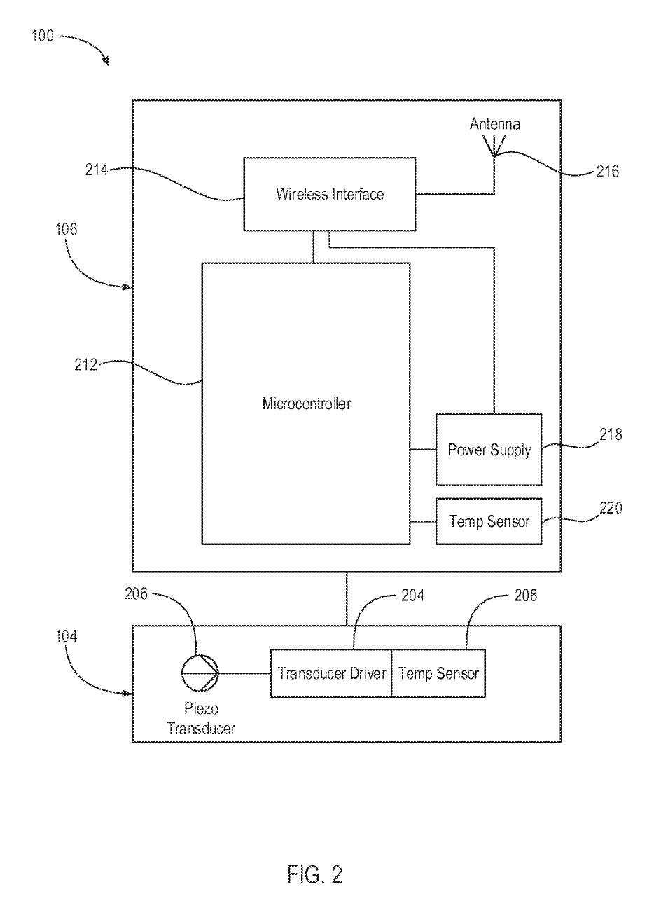

Referring to FIG. 2, a block diagram of an ultrasonic fuel level monitoring system 100 is shown. The system 100 includes an ultrasonic sensor 104 comprising a transducer driver 204, an emitter 206 to emit an ultrasonic beam, and a temperature sensor 208. The emitter 206 may be embodied as a piezoelectric crystal transducer or piezo 206. When excited, the piezo 206 emits an ultrasonic beam. Increasing the piezo diameter increases the transmission power, as power increases with the square of the piezo radius. Increasing the piezo diameter narrows the hemispherical beam. A narrower beam has more power per unit area and is more likely to receive an echo. The temperature sensor 208 may be used to obtain a measurement of the temperature of the liquid inside the tank, which is desirable in order to adjust readings taken of the speed of sound for accuracy of the final fill levels (e.g., within plus or minus 1-2% of the tank fill level).

A control unit 106 is in electrical communication with the ultrasonic sensor 104 and may, in one embodiment, comprise a low-power microprocessor or microcontroller 212. The microcontroller 212 may be in electrical communication with a wireless interface or radio 214, an antenna 216, a battery power supply or external power supply 218, and an ambient temperature sensor 220. To minimize size and cost, the wireless interface or radio 214 may be a simplex radio capable of transmitting but not receiving. Alternatively it is possible to use a duplex radio system, which is more complex and both receives messages to measure the tank fill level and broadcasts the results of such requests for measurement. As disclosed herein, a user may secure measurements at specific times by manually initiating a command and electronically initiating a command. A command may be wirelessly initiated through input from satellites.

The wireless interface or radio 214 provides communication with a satellite service or a cellular service, or a combination of both, to provide a telemetry function to send the data. The data may or may not include GPS data relating to a vehicle position.

The wireless interface or radio 214 may also receive instruction for the control unit 106 to activate the on/off states of the ultrasonic sensor 104. Thus, the wireless interface 214 may receive a signal over a satellite network, cellular network, LAN, broadcast radio, line-of-sight microwave or the like to activate an on/off state. In this manner, an On Demand measurement may be made at any time through wireless communication. For example, a signal may be sent over a satellite/cellular network at any time to activate an on/off state and take a measurement. A signal may also be generated at a facility access/exit point so that a measurement is taken every time a vehicle enters or leaves a facility.

The control unit 106 may operate according to a predetermined schedule and activate the on/off states of the ultrasonic sensor 104 to take measurements. The schedule may be stored in a control unit memory and updated when desired. In one embodiment, the schedule may be updated through communication with the wireless interface 214.

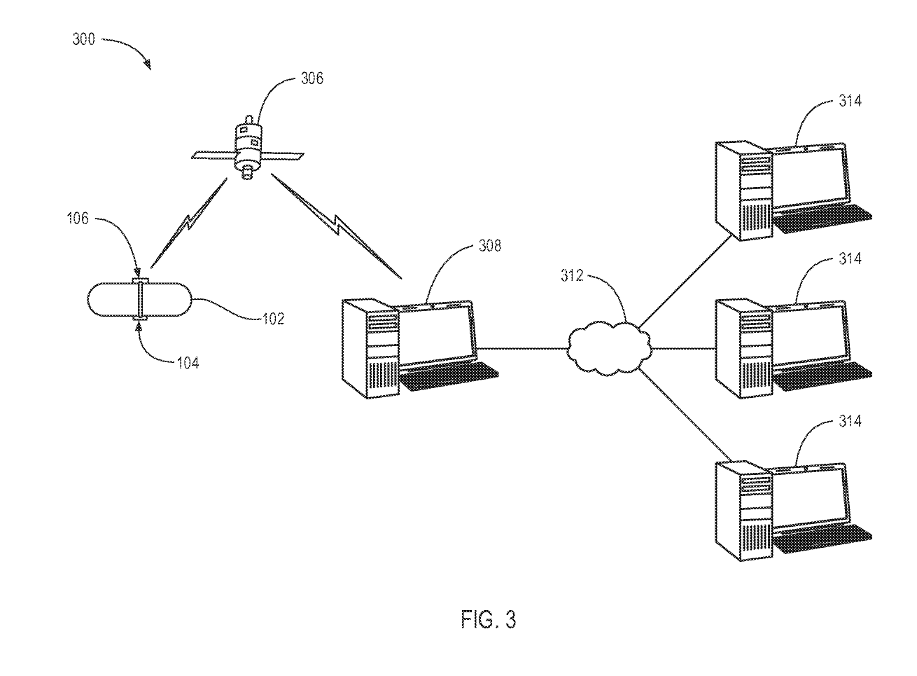

Referring to FIG. 3, a working environment 300 is shown wherein data collected by a control unit 106 from an ultrasonic sensor 104, including time-of-flight and temperature data, is transmitted by radio from the control unit 106 via a data link 306 to a ground station computer 308. The ground station computer 308 includes a computer-readable storage medium that receives the data input and, together with previously stored information on tank geometry and dimensions and a suitable computer program product, processes the received data to calculate a measure of the fuel volume in a tank 102. The calculated measure may also be stored in the storage medium and may be read out and displayed by the computer 308. The computer 308 may be in electrical communication with a network 312, such as a satellite network, cellular network, LAN, WAN, or the internet. One of skill in the art will appreciate that the data link 306 may also include, in whole or in part, a network similar to the network 312. Through the network 312, the calculated measure may be read out and displayed on a multiplicity of computers 314, or forwarded to the end users via web service methods.

The ultrasonic sensor 104 may be sleeping and silent and unpowered during all phases of operation except when a liquid level reading is requested. The control unit 106 may be programmed to take measurements at certain predetermined times. For example, the control unit 106 may be timed to wake up at intervals (e.g., every 16 seconds) to determine the time of day, and to compare that time with a sensing and transmission schedule programmed in a microcontroller. If the system is not scheduled to either “ping” the tank 102 or transmit measurement information via satellite radio, then the control unit 106 may go back to sleep. If an electronic request for an On Demand measurement is made by outside inputs to the control unit 106, the system awakens and proceeds with measurement of the tank 102 and sending of the data.

When the ultrasonic sensor 104 wakes up, it may be programmed to listen for a set of commands sent to it by the control unit 106. A ping may be generated by a microcontroller command from the control unit 106. A pulse train of pulses is then switched into the piezo to generate the transmitted ultrasonic packet. As the piezo begins to oscillate, it transmits the ultrasonic ping packet into the acoustic lens. From the acoustic lens, the ultrasonic wave packet transits a region of acoustic coupling agent, such as a water-based gel, a silicon rubber, or some other form of acoustically transparent medium. The ultrasonic wave packet then transits the tank wall and enters the liquid of the product in the tank 102. The ultrasonic packet has a wave front shaped by acoustic lens, the tank wall, and the differences in the velocity of sound of the media through which the pulse is traveling. The wave front is reflected back off the underside of the liquid surface, returning an echo to the ultrasonic sensor 104 creating a time of flight (TOF) for the ultrasonic packet to travel in both directions.

The ground station computer 308 may be used to upload software changes and/or schedule changes to the control unit 106. Thus, the ground station computer 308 may monitor and regulate the on/off states and measurement taking both for On Demand use and for predetermined schedules. Furthermore, the ground station computer 308 may monitor the position of the control unit 106 and tank 102, when mobile, and take measurements based on a geographic position. The geographic position may be determined according to a geographic area, such as geofencing, may be determined by proximity to certain landmarks, and/or may be determined by mileage. In any of these events, the wireless interface 214 may receive a signal to take a measurement, or the On Demand measurement may be triggered electronically via other input devices in or on the vehicle or tank 102.

As used herein, “On Demand” refers to a user-initiated action to immediately take a measurement rather than taking a measurement according to a predetermined schedule. An input device in electrical communication with the system allows a user to send a signal to the control unit 106 when desired. The input device may be configured as an electronic device operated manually, such as a toggle, keypad, or switch. The input device may also include the wireless interface 214, as the wireless interface 214 may receive a signal to initiate a measurement On Demand.

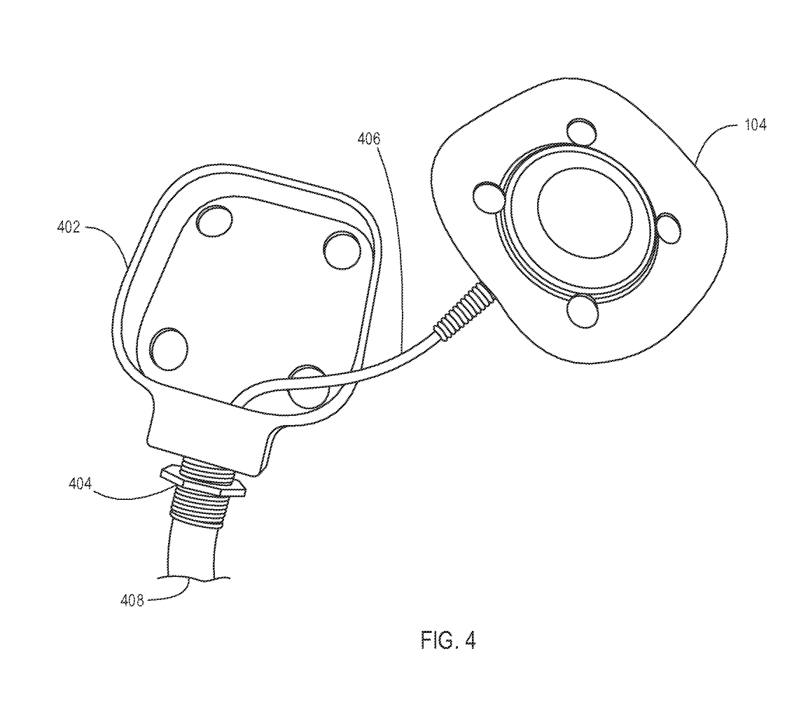

Referring to FIG. 4, an embodiment of an ultrasonic sensor 104 and a sensor guard 402 is shown. The sensor guard 402 covers the ultrasonic sensor 104 when it is mounted to a tank 102, thereby protecting the ultrasonic sensor 104 from the external environment. The sensor guard 402 may further comprise a connector 404 for connecting a conduit 408 through which a sensor cable 406, which electrically connects the ultrasonic sensor 104 to a control unit 106, may be inserted. The conduit thereby protects the sensor cable from the external environment.

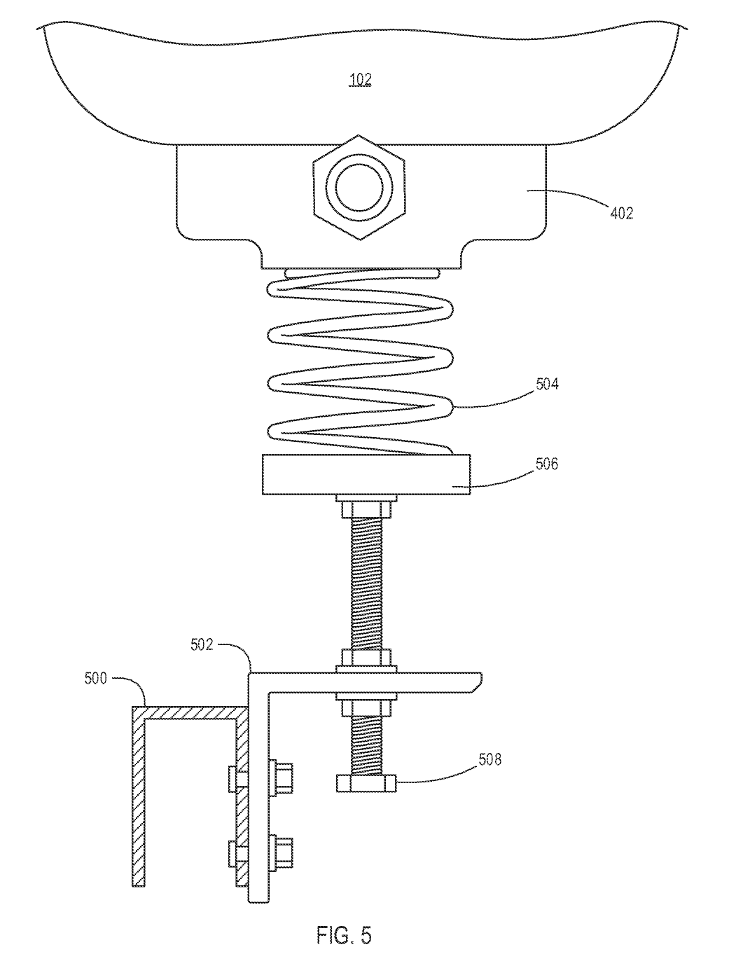

Referring to FIG. 5, an embodiment of a sensor guard 402 attached to a truck frame assembly 500 is shown. An adjustable pressure spring 504 may be disposed between the sensor guard 402 and the truck frame support assembly 502 to provide damping and to minimize vibrations and other forces that may be encountered during the course of travel or maintenance. The pressure spring 504 may be connected at one end to a spring holder 506. A bolt 508 connected to the spring holder 506 and the truck frame support assembly 502 may be used to compress or extend the pressure spring 504 by tightening or loosening the bolt 508. Proper spring adjustment assures the ultrasonic sensor is affixed to the bottom center of the tank, giving the best possible sensor performance. Too little pressure or too much pressure can alter the tank measurement results obtained from the ultrasonic sensor.

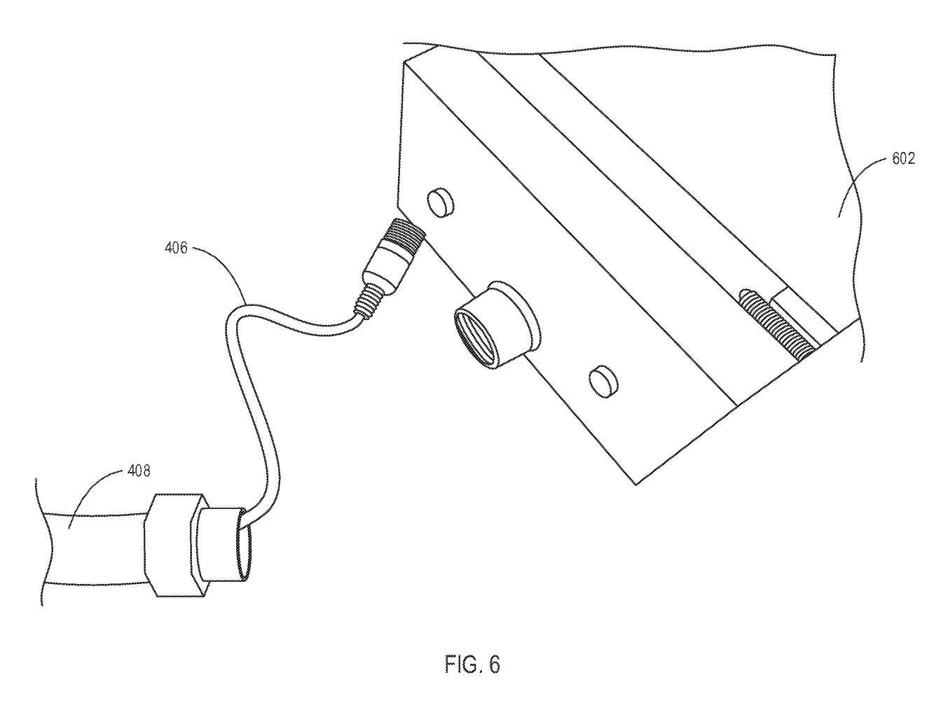

Referring to FIG. 6, an embodiment of a control unit guard 602 is shown. The control unit guard 602 provides a secure housing for the control unit 106 and optionally other components of the system. The control unit guard 602 may comprise a connector to which a conduit 408 carrying a sensor cable 406 may be connected.

The control unit guard 602 surrounds and protects the system, including the control unit 106. The control unit guard 602 may be constructed of, for example, a metal (e.g., steel) or any other suitably strong or durable material. The control unit guard 602 may take any suitable shape and size, such that it may partially or completely surround the entire system or only certain components of the system. The control unit guard 602 may optionally comprise a removable cover and/or removable sealing plug to provide limited access to the interior of the control unit 106.

Furthermore, the control unit guard 602 may be locked or otherwise secured through the use of locks, clasps or other fasteners (e.g., bolts) to prevent it from being removed or otherwise accessed. The control unit guard 602 thereby provides a secure barrier between the system and the external environment. Thus, the control unit guard 602 protects the system from, for example, road hazards, power washes, and other potential damage that may occur in the course of travel or maintenance. The control unit guard 602 also protects against tampering so that fuel level measurements may be performed reliably and without disruption. Regrettably, conventional systems do not prevent drivers or other persons from tampering with measurement results. Thus, a system utilizing a box with a switch would simply allow the driver to turn it off. By enclosing the control unit 106 in the control unit guard 602, such tampering is reduced or eliminated.

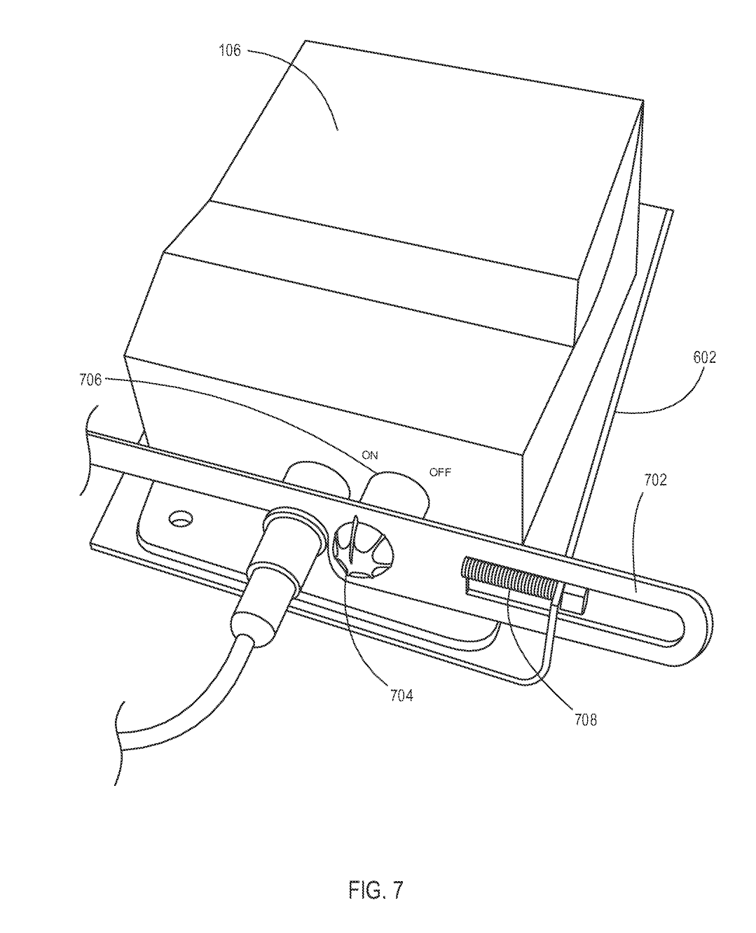

Referring to FIG. 7, an embodiment of a control unit 106 mounted in a control unit guard 602 is shown. A cutaway view of the control unit guard 602 is provided to show the control unit 106 within. As is shown in this embodiment, the system may further include an activator arm 702 for manual activation and/or deactivation of the system or of specific components of the system. The activator arm 702, and other devices that allow user-initiated measurements On Demand, may also be referred to herein as an input device. The activator arm 702 allows for operation or limited operation of the control unit 106 even when it is placed inside the control unit guard 602. In one embodiment, the activator arm 702 extends into the interior of the control unit guard 602. The portion of the activator arm 702 extending into the control unit guard 602 may comprise an activator tip 704 for interacting with a part of the control unit 106. For example, the activator arm 702 may comprise a rubber grommet for interacting with an on/off toggle switch 706 on the control unit 106. Such a switch may, for example, control the “on” and “off” states of the entire system or of any individual component of the system, such as the ultrasonic sensor. A portion of the activator arm 702 extends outside of the control unit guard 602 so that a user may operate or otherwise manipulate the activator arm 702 to interact with the control unit 106. For example, a user may pull or push on the activator arm 702 to toggle the on/off switch 706 on the control unit 106.

The activator arm 702 may be biased to interact with the control unit 106 in a certain manner. For example, the activator arm 702 may be biased toward the “on” position of the on/off toggle switch 706 on the control unit 106. In one embodiment, such biasing may be provided by a spring-loaded activator arm. In operation, the activator arm 702 works as follows. The activator arm 702 interacts with the on/off toggle switch 706 on the control unit 106 and comprises a spring 708 that causes the activator arm 702 to be biased towards the “on” position. When the activator arm 702 is initially pulled, a microprocessor interrupt event occurs and the system is turned off (i.e., the switch is toggled to the “off” position). When the user releases the activator bar, the spring 708 returns the activator arm 702 to the “on” position. The system wakes up, or returns to the “on” state, and upon doing so, a measurement event occurs. The system may then send the fuel level measurement data via satellite to a remote computing device. The system may further be configured to send signals, including signals carrying measurement data, individually or redundantly, or both. By sending multiple redundant signals, the chance of at least one signal being successfully received is increased.

The activator arm 702 allows for the system to provide On Demand measurements. That is, the system may provide measurements On Demand when the activator arm 702 is pulled by a driver or other authorized user. For example, a driver may be instructed to perform a measurement On Demand at a certain time of the day or at certain events, such as when leaving or arriving at a refinery or other specific points where an electronic trigger calls for a measurement of the tank. This could be caused by geofencing, satellite signal, closing a valve or opening a door on the vehicle transporting the tank.

The system may also be configured to perform measurements at predetermined scheduled times. This feature may be used as an alternative to, or in addition to, the manual On Demand feature described above. In this embodiment, the scheduled measurements may occur automatically, thereby eliminating the need for a user to be involved in, or even aware of, the taking of a measurement.

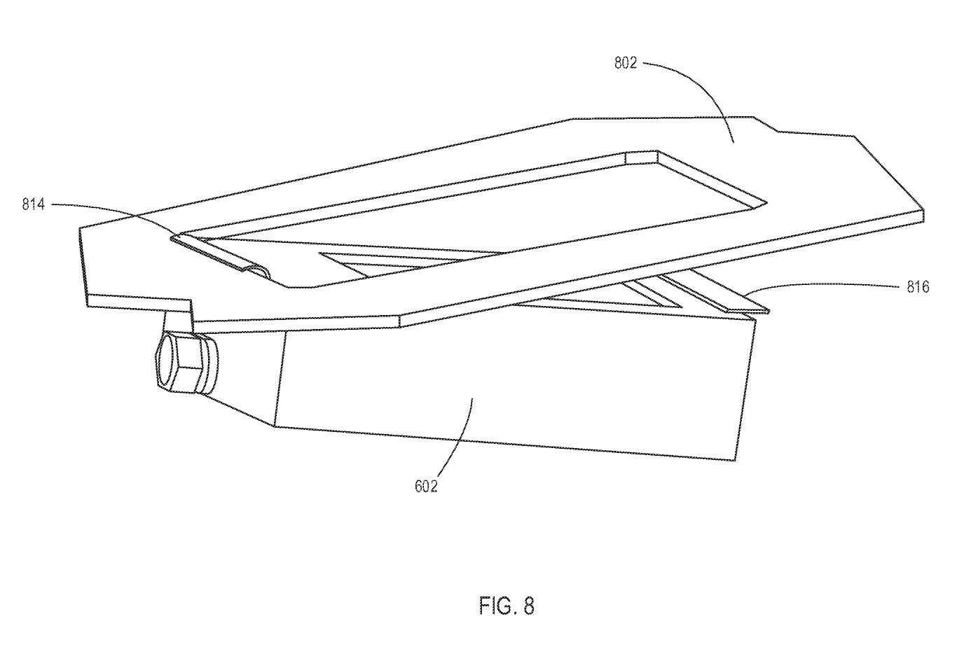

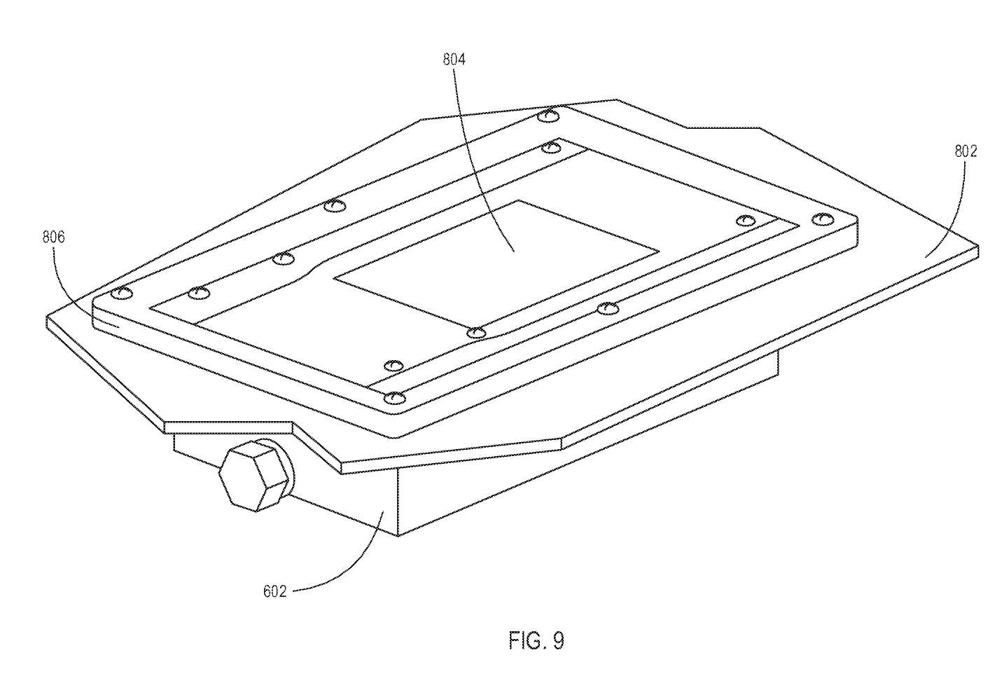

Referring to FIGS. 8 and 9, an embodiment is shown in which a control unit guard 602 is securely mounted to a surface 802 of a truck or other vehicle. The control unit guard 602 may comprise one or more tabs 814, 816 to secure the control unit guard 602 within a hole cut in the surface 802. A cover plate 804 and gasket 806 may also be installed to cover the top portion of the control unit guard 602. Bolts or other fasteners may also be used to secure the control unit guard 602, cover plate 804 and gasket 806 in place.

In an embodiment, the system may be installed and arranged on a fuel truck as follows. The system, and the accompanying installation equipment, includes an ultrasonic sensor, a sensor guard with a conduit connector, a control unit, a mobile install kit for the vertical spring assembly, a mobile install kit for the control unit guard, a mobile install kit for a truck frame support kit, all necessary tools for installation (including metric wrenches), and a truck template for truck box cutout and bolt location verification. As stated above, suitable systems include one or more components disclosed in U.S. Pat. Nos. 7,287,425, 7,245,059, 7,905,143, and 8,412,473, the contents of which are herein incorporated by reference in their entireties. Installation may further utilize an installation application on a computer device, such as a tablet or smartphone, and wireless communication, such as Bluetooth, between the local computer device and the control unit.

To begin installation, the user selects a location on the bottom centerline of the tank to install and test the ultrasonic sensor. The selected location allows the installation of the truck frame support with no interference. A bottom surface of a vehicle is prepared for installation of the system. The user cleans the contact point on the tank bottom where the ultrasonic sensor is to be tested. The user then installs the ultrasonic sensor on the bottom centerline of the tank in a manner disclosed in U.S. Pat. Nos. 7,287,425, 7,245,059, 7,905,143, and 8,412,473, the contents of which are hereby incorporated by reference in their entireties. Next, the sensor cable is connected to the control unit and plugged into a wireless (e.g., Bluetooth) module and battery.

An installation application comprising a graphic user interface (GUI) may be used to aid the installation. The installation application allows selection of the setting “locate sensor” to ensure the location is proper. The installation application provides either a “pass” or “fail” notification to the user through the GUI. Once this “locate sensor” step is accomplished successfully, the user may remove the wireless module and may disconnect the battery to save power.

A user may then cut the conduit to the proper length so that a length of cable extends beyond the conduit. This allows the excess cable to coil inside the control unit guard. For example, the conduit length for an ultrasonic sensor with a 10-foot cable may be nine feet (2.74 meters). By way of another example, the conduit length for an ultrasonic sensor with a 16.5-foot cable may be 15.5 feet (4.72 meters).

The conduit connector may then be properly tightened into the sensor guard. The end of the conduit is inserted (without the cable) into the connector with the nut and sealing washer. The conduit connector nut is tightened onto the outside diameter of the conduit on the sensor guard end.

The sensor cable may then be inserted through the conduit that is coupled to the sensor guard. This may result in nine inches or more (228 mm) of the sensor cable extending beyond the end of the conduit on the control unit guard end.

Once the location of the ultrasonic sensor is confirmed, the user then installs a truck frame support assembly. The truck frame support assembly includes frame end pieces which are firmly fitted into the inside of the truck frame rail. Attention is made to avoid wires and other obstacles within the frame body.

Once the truck frame support assembly is in place, the user establishes the proper vertical alignment between the pressure spring and the sensor guard. The user captures both ends of the spring (e.g., a three-inch (76 mm) spring) and engages the ends into the holding grooves within the top and bottom of the spring holders.

Once the truck frame support assembly is aligned properly, a bolt (e.g., M10 bolt) is turned until the spring is compressed to approximately 1.75 inches (32 mm) in total length between the bottom of the sensor guard and the top of the lower spring holder. The user then verifies that this operation has not altered the alignment of the center of the ultrasonic sensor to the center of the spring and spring bottom mounting support.

The user may then tighten the truck frame support frame locking system to secure the bottom of the system to the truck frame rails. The user verifies tightness of all the bolts (e.g., M6 bolts) throughout the assembly. The truck frame support assembly is used to ensure the ultrasonic sensor is properly affixed to the bottom of the truck tank during operations. One familiar with the multiplicity of designs of truck frames realizes they are various ways to attach the frame support to the main frame of the truck.

The user may then route the conduit through the truck frame to ensure no cable or conduit is loose under the truck. There should be sufficient conduit to reach inside the truck box on the back of the truck. The following steps can be best accomplished by working on the elevated floor inside the truck box along with the conduit and the digital guard assembly. The user secures the conduit and cable into the control unit guard and tightens the conduit connector onto the control unit guard.

The user then removes and sets aside the round plastic sealing plug (e.g., two-inch (51 mm) diameter) from the bottom of the control unit. The user then holds the control unit and cable above the control unit guard and connects the cable tightly into the connection on the control unit. The user lowers the control unit into the control unit guard assembly in a manner that ensures the extra cable length does not interfere with the action of the spring-loaded activator arm. During this process, the user carefully guides the actuator rubber grommet onto the control unit on/off toggle switch.

The user may then use the multiple screws (e.g., four M4×12 mm #XMC136016 screws) with locknuts to secure the control unit to the inside floor of the control unit guard. If desired, the user may use tiebacks to secure the cable out of the way from the activator arm for the switch. The user then verifies the spring-loaded actuator is working properly and keeps the on/off switch in the “always on” position. The user removes the cover plate on the bottom of the control unit guard to expose the plug-in for the wireless/Bluetooth module and the battery wire connectors.

The user then cuts a hole in the truck box utilizing a template at the correct location. This location should be opposite the side of the hose reel position. The user ensures that the surface of the truck box at the cutout location is as flat as possible. There should also be enough space so that when the control unit is fully installed, there is enough room, on the inside and around the perimeter of the control unit guard, to easily attach bolts as necessary.

The user then passes the assembled control unit guard assembly upwards into the cutout in the truck box, allowing the front guard end tab to hold the assembly onto the top surface of the truck box. The user pushes up the back end and engages the rear guard tab on top of the truck box cutout.

The user then installs a cover plate (e.g., Plexiglas) and gasket to the top side, bolting the cover plate directly onto the holes on the exposed top of the control unit guard. The user inserts the mounting bolts (e.g., M6×40 mm) that will secure the cover plate into the truck box, with the gasket between the cover plate and the steel truck box to provide a weather seal.

The user then may verify the routing of the conduit through the truck frame and secure it with tiebacks to ensure no cable or conduit is loose in or under the truck. Once the physical installation of the system is completed and secured into place, the final setup calibration can be performed. The user reaches to the underside of the control unit guard and installs the wireless module (e.g., Bluetooth), connects the battery, and runs the setup program.

The user installer starts the installation application and enters the final information about truck identifier, company, etc., ensuring entry of the proper tank data. The user installer then runs the calibration program to train the ultrasonic sensor for that specific truck tank. Once the program has run and the user installer pushes the “finish” button, the Bluetooth module is removed, leaving the battery plugged in. The user installer retrieves the two-inch round plastic sealing plug and inserts it into the bottom of the control unit to seal the control unit. The user verifies the plug is fully inserted and then attaches the metal bottom cover of the control unit guard and screws it into place. A user waits for the radio commissioning message to be received and posted on the website. Upon successful commissioning of the system, the system sends additional test measurements. The user waits for at least one of these messages before attempting to send a first On Demand message by pulling the activator arm. The activator arm is spring-loaded and only needs to be activated once. Once activated, the user may allow a full five minutes between attempts to measure and send an On Demand message.

Alternatively a separate cable from the control unit allows external power to be applied to the control unit and also allows a method for attachment of the On Demand electronic triggering devices to the control unit.

The disclosure provides a ultrasonic fuel level measurement system to provide On Demand measurements and, if desired, provide measurements at specific times. In this manner, the system controls or reduces liquid theft by company employees or random theft. The system enables metering of discharge from the tank through random stopping points on a mobile route for client verification of delivery. The provided data of the tank fill levels may be used for bulk quantity purchase of fuels and to ensure adequate storage space in a fleet.

In alternative embodiments, a system may not include an activator arm and/or a control unit guard. An input device, manually operated by a user, may be placed in electrical communication with the control unit 106 to activate on/off states. The input device may be configured in a variety of ways to facilitate this operation. Thus, the input device may be coupled directly to the control unit 106 or even placed remote to the control unit 106 such as on the tank 102 or within a passenger compartment of the vehicle. The input device may be embodied as a keyboard, on/off toggle or switch to initiate an On Demand measurement.

This system provides for both scheduled measurements at specific times during both day and night and On Demand measurements. The specific times may be set during system installation with a mobile or a fixed tank. The On Demand measurements may be taken at any time by activation at the mobile or fixed unit. The On Demand measurements may be taken at times corresponding with specific events. For example, a multiplicity of events may trigger an On Demand measurement, and these include a tank valve being turned on or off, a vehicle door opening or closing, a fixed or mobile pump being turned on or off, a lip of a tank being opened or closed, or any other event that is important to the end user.

This disclosure has been made with reference to various exemplary embodiments, including the best mode. However, those skilled in the art will recognize that changes and modifications may be made to the exemplary embodiments without departing from the scope of the present disclosure. While the principles of this disclosure have been shown in various embodiments, many modifications of structure, arrangements, proportions, elements, materials, and components may be adapted for a specific environment and/or operating requirements without departing from the principles and scope of this disclosure. These and other changes or modifications are intended to be included within the scope of the present disclosure.

This disclosure is to be regarded in an illustrative rather than a restrictive sense, and all such modifications are intended to be included within the scope thereof. Likewise, benefits, other advantages, and solutions to problems have been described above with regard to various embodiments. However, benefits, advantages, solutions to problems, and any element(s) that may cause any benefit, advantage, or solution to occur or become more pronounced are not to be construed as a critical, required, or essential feature or element. The scope of the present invention should, therefore, be determined by the following claims.

What is claimed is:

1. An ultrasonic liquid level measurement system mountable to a tank to measure a liquid level in the tank, comprising:
an ultrasonic sensor including an emitter to generate an ultrasonic beam to pass through a tank wall and to receive an echo of the ultrasonic beam off a liquid surface;
a control unit in electrical communication with the ultrasonic sensor to activate on/off states of the ultrasonic sensor, wherein the on state generates an ultrasonic beam to measure the liquid level in the tank and thereby provide measurement data;
an input device coupled to the control unit and configured to enable manual user operation to control the on/off states; and
a wireless interface in electrical communication with the control unit and configured to receive a command to control the on/off states.

2. The ultrasonic liquid level measurement system of claim 1, further comprising a control unit guard at least partially housing the control unit.

3. The ultrasonic liquid level measurement system of claim 2, wherein the input device includes an activator arm extending from an exterior of the control unit guard to an interior of the control unit guard.

4. The ultrasonic liquid level measurement system of claim 3, wherein the control unit includes an on/off toggle switch and the activator arm includes an activator tip to engage the on/off toggle switch.

5. The ultrasonic liquid level measurement system of claim 2, wherein the control unit guard is configured to be securely mounted to the tank on a vehicle.

6. The ultrasonic liquid level measurement system of claim 2, wherein the control unit is substantially enclosed within the control unit guard.

7. The ultrasonic liquid level measurement system of claim 1, wherein the control unit further comprises a memory including preprogrammed instructions to operate the on/off states according to a schedule.

8. The ultrasonic liquid level measurement system of claim 7, wherein the preprogrammed instructions are configured to update the schedule in response to a command received through the wireless interface.

9. The ultrasonic liquid level measurement system of claim 1, wherein the tank is mounted to a vehicle.

10. The ultrasonic liquid level measurement system of claim 1, further comprising a sensor guard housing the ultrasonic sensor.

11. The ultrasonic liquid level measurement system of claim 10, further comprising a pressure spring coupled to the sensor guard.

12. An ultrasonic liquid level measurement system mountable to a tank to measure a liquid level in the tank, comprising:
an ultrasonic sensor including an emitter to generate an ultrasonic beam to pass through a tank wall and to receive an echo of the ultrasonic beam off a liquid surface;
a control unit in electrical communication with the ultrasonic sensor to activate on/off states of the ultrasonic sensor, wherein the on state generates an ultrasonic beam to measure the liquid level in the tank and thereby provide measurement data, the control unit including a memory storing preprogrammed instructions to operate the on/off states according to a predetermined schedule; and
an input device coupled to the control unit and configured to enable manual user operation to control the on/off states.

13. The ultrasonic liquid level measurement system of claim 12, further comprising a control unit guard at least partially housing the control unit.

14. The ultrasonic liquid level measurement system of claim 13, wherein the input device includes an activator arm extending from an exterior of the control unit guard to an interior of the control unit guard.

15. The ultrasonic liquid level measurement system of claim 13, wherein the control unit includes an on/off toggle switch and the activator arm includes an activator tip to engage the on/off toggle switch.

16. The ultrasonic liquid level measurement system of claim 13, wherein the control unit guard is configured to be securely mounted to the tank on a vehicle.

17. The ultrasonic liquid level measurement system of claim 13, wherein the control unit is substantially enclosed within the control unit guard.

18. An ultrasonic liquid level measurement system mountable to a tank to measure a liquid level in the tank, comprising:
an ultrasonic sensor including an emitter to generate an ultrasonic beam to pass through a tank wall and to receive an echo of the ultrasonic beam off a liquid surface;
a control unit in electrical communication with the ultrasonic sensor;
a control unit guard housing the control unit; and
an activator arm extending from an exterior of the control unit guard into an interior of the control unit guard and interacting with the control unit to activate on/off states of the ultrasonic sensor, wherein the on state generates an ultrasonic beam to measure the liquid level in the tank and thereby provide measurement data.

19. The ultrasonic liquid level measurement system of claim 18, wherein the control unit guard is configured to be securely mounted to the tank on a vehicle.

20. The ultrasonic liquid level measurement system of claim 18, wherein the control unit is substantially enclosed within the control unit guard.

21. The ultrasonic liquid level measurement system of claim 18, wherein the activator arm comprises a biasing member disposed on the exterior of the control unit guard to bias the control unit into one of the on/off states.

22. The ultrasonic liquid level measurement system of claim 21, wherein the biasing member includes a spring.

23. The ultrasonic liquid level measurement system of claim 18, wherein the system provides a measurement when the activator arm is manually operated and interacts with the control unit.

24. The ultrasonic liquid level measurement system of claim 18, wherein the control unit is configured to obtain measurements according to a predetermined schedule.

25. The ultrasonic liquid level measurement system of claim 18, wherein the control unit comprises a wireless interface configured to transmit measurement data wirelessly from a remote location.

26. The ultrasonic liquid level measurement system of claim 25, wherein the measurement data is transmitted via a satellite network.

27. The ultrasonic liquid level measurement system of claim 25, wherein the measurement data is transmitted via a cellular network.

28. The ultrasonic liquid level measurement system of claim 18, further comprising a sensor guard housing the ultrasonic sensor.

29. The ultrasonic liquid level measurement system of claim 28, further comprising a pressure spring coupled to the sensor guard.

30. The ultrasonic liquid level measurement system of claim 18, wherein the control unit includes an on/off toggle switch and the activator arm includes an activator tip to engage the on/off toggle switch.

31. The ultrasonic liquid level measurement system of claim 18, further comprising:
a cover plate; and
a gasket, wherein the cover plate and gasket are disposed between the control unit guard and the tank.

32. A method for monitoring a liquid level in a tank, comprising:
providing an ultrasonic sensor including an emitter to generate an ultrasonic beam to pass through a tank wall and to receive an echo of the ultrasonic beam off a liquid surface;
providing a control unit in electrical communication with the ultrasonic sensor to activate on/off states of the ultrasonic sensor wherein the on state generates an ultrasonic beam to measure the liquid level in the tank and thereby provide measurement data;
the control unit activating the on/off states according to a predetermined schedule stored in a control unit memory; and
providing an input device in electrical communication with the control unit to activate the on/off states, the input device configured to allow manual operation to enable user-initiated measurement on demand.

33. The method of claim 32, further comprising a wireless interface, in electrical communication with the control unit, and a signal to activate the on/off states.

34. The method of claim 33, further comprising the wireless interface transmitting the measurement data via a satellite network.

35. The method of claim 33, further comprising the wireless interface transmitting the measurement data via a cellular network.

36. The method of claim 32, wherein the control unit includes an on/off toggle switch and the input device includes an activator arm to engage the on/off toggle switch.

37. A method for monitoring a liquid level in a tank, comprising:
providing an ultrasonic sensor including an emitter to generate an ultrasonic beam to pass through a tank wall and to receive an echo of the ultrasonic beam off a liquid surface;
providing a control unit in electrical communication with the ultrasonic sensor;
manually operating an input device in electrical communication with the control unit to activate on/off states of the ultrasonic sensor, wherein the on state generates an ultrasonic beam to measure the liquid level in the mobile tank and thereby provide measurement data;
the control unit including a memory storing preprogrammed instructions to operate the on/off states according to a predetermined schedule; and
providing an input device coupled to the control unit and configured to enable manual user operation to control the on/off states.

38. The method of claim 37, further comprising securing the control unit guard to the tank on a vehicle.

39. The method of claim 37, wherein the control unit guard substantially encloses the control unit.

40. The method of claim 37, wherein the activator arm includes a biasing member disposed on the exterior of the control unit guard to bias the control unit into one of the on/off states.

41. The method of claim 39, wherein the biasing member includes a spring.

42. The method of claim 37, further comprising the control unit generating command signals according to a predetermined schedule to obtain liquid level measurements.

43. The method of claim 37, wherein the control unit further includes a wireless interface configured to transmit measurement data wirelessly from a remote location.

44. The method of claim 43, further comprising transmitting the measurement data via a satellite network.

45. The method of claim 43, further comprising transmitting the measurement data via a cellular network.

46. The method of claim 37, further comprising providing a sensor guard to house the ultrasonic sensor.

47. The method of claim 37, further comprising providing a pressure spring coupled to the sensor guard.

48. The method of claim 37, wherein the control unit includes an on/off toggle switch and the activator arm includes an activator tip to engage the on/off toggle switch.
